(19) United States
(12) Patent Application Publication
(10) Pub. No.: US 2023/0320286 A1
(43) Pub. Date: Oct. 12, 2023

(54) MUSHROOM CULTIVATION MEDIUM

(71) Applicant: SEIKO EPSON CORPORATION, Tokyo (JP)

(72) Inventors: Hisashi KOIKE, Suwa (JP); Shunichi SEKI, Suwa (JP); Akio ITO, Matsumoto (JP); Toshiaki MIKOSHIBA, Azumino (JP); Satomi YOSHIOKA, Shiojiri (JP); Takuya MIYAKAWA, Matsumoto (JP)

(21) Appl. No.: 18/297,666

(22) Filed: Apr. 10, 2023

(30) Foreign Application Priority Data
Apr. 12, 2022 (JP) 2022-065561

(51) Int. Cl. A01G 18/20

(52) U.S. Cl. CPC A01G 18/20

(57) ABSTRACT

Provided is a mushroom cultivation medium that easily maintains its shape and that is easy to handle. The mushroom cultivation medium includes cellulose fibers, a binder binding the cellulose fibers to each other, and wood chips mixed with the cellulose fibers.

The present application is based on, and claims priority from JP Application Serial Number 2022-065561, filed Apr. 12, 2022, the disclosures of which is hereby incorporated by reference herein in its entirety.

### BACKGROUND

### 1. Technical Field

The present disclosure relates to a mushroom cultivation medium.

### 2. Related Art

Media for artificial cultivation of mushrooms have been known in the related art. For example, JP-A-2020-178686 discloses a Tricholoma bakamatsutake culture medium including voids and a medium constituent containing a substrate, such as sawdust.

### SUMMARY

It is, however, difficult to maintain the shape of the mushroom cultivation medium disclosed in JP-A-2020-178686 when the mushroom cultivation medium is used as a formed body. Specifically, the substrate, such as sawdust, is composed of particles, and the particles tend to be weakly bonded to each other. The cultivation medium in the form of a sheet or block-like formed body may thus easily deform and may be difficult to handle. There is a need for a mushroom cultivation medium that easily maintains its shape and that is easy to handle.

A mushroom cultivation medium includes cellulose fibers, a binder binding the cellulose fibers to each other, and wood chips mixed with the cellulose fibers.

### BRIEF DESCRIPTION OF THE DRAWINGS

FIG. 1 is a schematic cross-sectional view of the structure of a mushroom cultivation medium according to an embodiment.

FIG. 2 is a comparison table for mushrooms and trees suitable for cultivation.

FIG. 3 is a schematic plan view of a form of the mushroom cultivation medium.

FIG. 4 is a schematic plan view of a form of the mushroom cultivation medium.

FIG. 5 is a schematic view of the form of use of the mushroom cultivation medium.

FIG. 6 is a schematic view of the structure of a formed-body manufacturing apparatus used to manufacture the mushroom cultivation medium.

FIG. 7 is a schematic view of the structures of a transport unit, a screen unit, and a second web forming unit.

### DESCRIPTION OF EXEMPLARY EMBODIMENTS

In an embodiment described below, a sheet-like mushroom cultivation medium formed by a dry process and an apparatus for manufacturing the mushroom cultivation medium are illustrated and described with reference to the drawings. The dry process as used herein refers to a process not in a liquid, such as water, but in a gas, such as atmosphere. The mushroom cultivation medium of the present disclosure is not limited to a sheet shape, and may be, for example, a block shape, a conical shape, a columnar shape, or an amorphous shape.

In the figures described below, coordinate axes perpendicular to each other are assigned with XYZ-axes as necessary. The direction pointed by each arrow is defined as a positive direction, and the direction opposite to the positive direction is defined as a negative direction. The Z-axis is a virtual axis along the vertical direction. The positive Z-direction is defined as an upward direction, and the negative Z-direction is defined as a downward direction.

For convenience of illustration, the size of each member is different from the actual size.

### 1. Mushroom Cultivation Medium

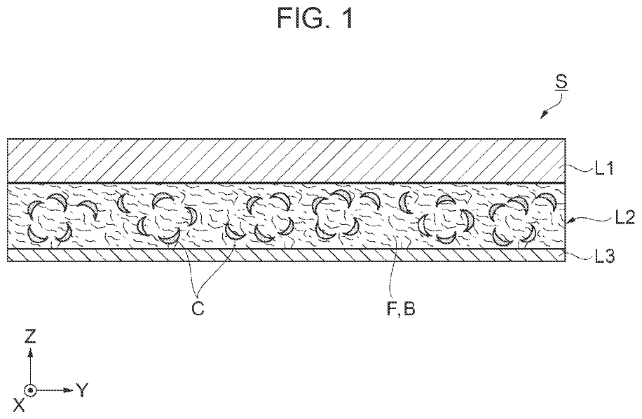

Referring to FIG. 1, a mushroom cultivation medium S according to an embodiment includes a first layer L1, a second layer L2, and a third layer L3, which are stacked on top of each other in this order from above to below. The mushroom cultivation medium S has a sheet shape. The mushroom cultivation medium S has two surfaces facing each other in the vertical direction. In the following description, the mushroom cultivation medium S may be referred to simply as a medium S. In the medium S, the second layer L2 is a main constituent of the medium S, and the first layer L1 and the third layer L3 are not essential constituents.

The second layer L2 contains a cellulose fiber F, a binder B, and a wood chip C. A plurality of the wood chips C is mixed with a plurality of the cellulose fibers F. In other words, the second layer L2 contains a plurality of the wood chips C entangled with a plurality of the cellulose fibers F. The second layer L2 may include small voids.

The cellulose fiber F is one of main components of the second layer L2. The cellulose fiber F is a relatively abundant natural material derived from plants. The cellulose fiber F is obtained by fibrillating a raw material, such as paper, cardboard, pulp, pulp sheets, sawdust, wood shavings, and wood. The cellulose fiber F may be made from trees corresponding to the type of mushroom cultivated in the medium S for the same reason as the wood chip C, which will be described below.

The cellulose fiber F is composed mainly of cellulose, but may contain components other than cellulose. Examples of components other than cellulose include hemicellulose and lignin.

The cellulose fibers F may have an average fiber length of 0.5 mm or more and 2.0 mm or less. The cellulose fibers F having this average fiber length are moderately entangled with each other, and it is easier to maintain the shape of the medium S. The average fiber length of the cellulose fibers F is measured by a staple diagram method.

The use of the cellulose fibers F promotes measures against environmental problems and conservation of underground resources. The cellulose fibers F are advantageous in availability and costs of raw materials. The cellulose fibers F have a high theoretical strength among various fibers and increase the strength of the medium S.

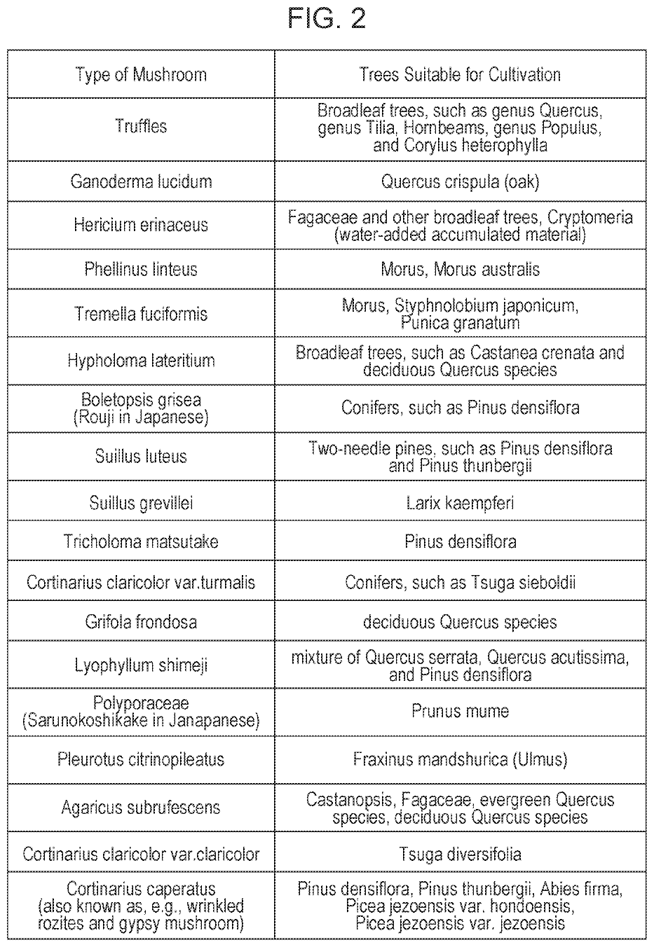

The wood chips C are one of main components of the second layer L2 and nutrient sources for mushrooms cultivated in the medium S. The wood chips C may include wood pieces from trees corresponding to the type of mushroom cultivated in the medium S. Specifically, for example, referring to FIG. 2, trees suitable for cultivation differ depending on the type of mushroom. For this, the taste and growth of mushrooms can be improved by using the wood chips C from trees corresponding to the type of mushroom.

Referring back to FIG. 1, the content of the wood chips C in the second layer L2 may be 10 vol % or more and 50 vol % or less with respect to the total volume of the second layer L2. With this content, sufficient nutrients are supplied to the mushroom cultivated in the medium S, and the content of the cellulose fibers F is ensured.

The wood chips C are prepared by, for example, the following method. Raw wood from trees is roughly milled and then milled into the wood chips C in a milling machine. The milling machine processes the raw wood into small pieces under the shear force and may be a known milling machine, such as a cutter mill. The cutter mill-type milling machine mills the raw wood under continuous shear with a rotary blade and a fixed blade. In such a milling machine, the wood chips C are processed into a predetermined smaller size and then collected through holes in a screen mesh.

The milling machine may be, instead of the cutter mill-type milling machine, a two-axis or three-axis milling machine having two or more roll blades, or a shredder, or other machines.

The binder B binds a plurality of the cellulose fibers F to each other. The cellulose fibers F are thus strongly bonded to each other in the medium S, so that the shape of the medium S is easily maintained. In addition to binding the cellulose fibers F to each other, the binder B may bind the cellulose fibers F and the wood chips C to each other, or may bind the wood chips C to each other.

The binder B may be derived from natural products from the viewpoint of low environmental impacts. Examples of the binder B include starch, protein adhesives, and wood component adhesives. Examples of protein adhesives include animal glue, casein glue, and soybean glue. Examples of wood component adhesives include lacquer, cellulose adhesives, and lignin adhesives.

Among the compounds described above, starch may be used as the binder B. Starch is gelatinized when exposed to water and heat to exhibit a binding force. Starch is derived from natural products and thus advantageous in low environmental impacts. In addition, starch functions as a nutrient source for mushrooms and a water-retaining agent in the medium S.

The second layer L2 may contain various additives in addition to the cellulose fibers F, the wood chips C, and the binder B. Examples of various additives include fertilizers, soil conditioners, pest repellents and pesticides, water-retaining agents, lactic acid bacteria and fermentation promoters, and ash.

Examples of fertilizers include nitrogen fertilizers, such as ammonium sulfate, ammonium chloride, and ammonium nitrate; phosphate fertilizers, such as superphosphate, heavy superphosphate, and fused phosphate fertilizers; potash fertilizers, such as potassium chloride and potassium nitrate; soybean meal; and chicken manure and horse manure.

Examples of soil conditioners include pH adjusters, such as organic lime, plant and wood ash, quicklime, and slaked lime.

Examples of pest repellents and pesticides include known chemically synthesized substances, such as camphor and naphthalene; and natural materials, such as camphor wood powder and cypress wood powder. These substances and natural materials may be used alone or in combination of two or more.

Examples of water-retaining agents include acrylate-vinyl alcohol copolymer, alkaline hydrolysate of starch-acrylonitrile graft copolymer, sodium acrylate polymer, and a mixture of two or more water-absorbing polymers.

Lactic acid bacteria suppress the activities of molds and aerobic fungi, which cause spoilage. Fermentation promoters promote the action of microorganisms, such as lactic acid bacteria, in the medium S.

Examples of ash include wood charcoal, bamboo charcoal, and coconut shell charcoal. Ash suppresses the growth of microbes and pests in the medium S.

The first layer L1 is disposed in the upper surface of the medium S, which is one of the two surfaces of the medium S. The first layer L1 is a fiber sheet having a water-holding capacity, and the second layer L2 is sandwiched between the first layer L1 and the third layer L3. When the first layer L1 has a water-holding capacity, water supplied to and held by the first layer L1 is supplied to the second layer L2 as appropriate. Water needed for mushroom cultivation can thus be supplied continuously.

The fiber sheet contains a plurality of fibers. In the fiber sheet, the fibers may be oriented in one direction, or the fibers may be randomly folded on top of one another. The fibers in the fiber sheet may be entangled with each other, and may be bonded to each other with a binding material or other materials. Specific examples of the fiber sheet include nonwoven fabrics and webs.

The binding material may be a thermoplastic resin or a thermosetting resin. Examples of the binding material include, in addition to the binder B described above, polyolefin, polyvinyl chloride, polystyrene, poly(meth)acrylate, polyester, polycarbonate, polyamide, polyoxymethylene, polyphenylene sulfide, polyphenylene ether, polyether ether ketone, acrylonitrile-styrene copolymer, and acrylonitrile-butadiene-styrene copolymer. Among the binding materials described above, the binder B derived from natural products may be used from the viewpoint of low environmental impacts.

The fiber sheet may be the same as the second layer L2 of the medium S except that the wood chips C, various additives, and other materials are absent in the second layer L2. The fiber sheet may be manufactured in a formed-body manufacturing apparatus 500 for manufacturing the medium S, which will be described below.

The third layer L3 is disposed in the lower surface of the medium S, which is one of the two surfaces of the medium S. The third layer L3 is a water-impermeable layer and is, for example, a resin sheet. Since the third layer L3 has water impermeability, the use of the medium S with the third layer L3 on the lower side in the vertical direction prevents water from permeating a lower part of the medium S and allows the second layer L2 to hold water. This prevents the second layer L2 from being dried and allows the second layer L2 to hold water needed for mushroom cultivation.

Examples of the resin sheet include known resin sheets and resin films, such as films made of polyamide, polyolefin, polyvinyl chloride, polyester, poly(meth)acrylate, and polytetrafluoroethylene. The third layer L3 may be a water-impermeable layer prepared by applying astringent juice of persimmon or other materials to water-permeable paper or other sheets.

The water impermeability as used herein refers to waterproof with a water pressure resistance of 300 mm or more. Specifically, the waterproof with a water pressure resistance of 300 mm means that, when a hollow quadrangular prism with a height of 300 mm and a cross-sectional area of one square centimeter is placed upright on a resin sheet, and pure water is poured into the quadrangular prism, the resin sheet withstands water pressure so that water does not permeate the resin sheet.

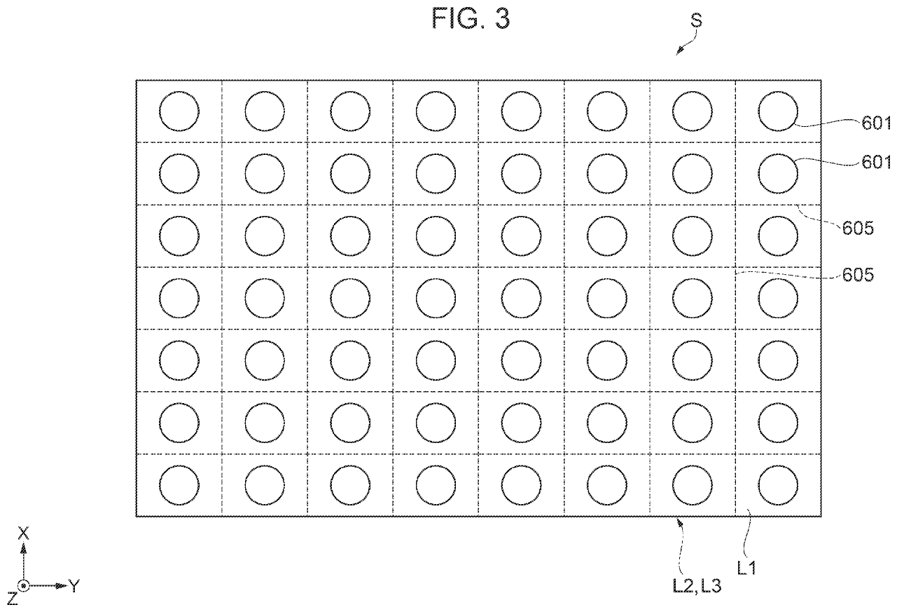

Referring to FIG. 3, the medium S has a substantially rectangular shape in plan view from above. The medium S has a plurality of processed sections 601 at the upper surface of the first layer L1. The processed sections 601 are arrayed in a matrix along the X-axis and the Y-axis. If the first layer L1 is absent in the medium S, the second layer L2 has the processed sections 601.

The processed sections 601 each have a substantially circular shape in plan view from above. The inside of each processed section 601 is recessed downward. With this configuration, mushroom mycelium is easily held in the recess of each processed section 601, and the mushroom can grow in regions including the processed sections 601.

The medium S has a plurality of cutting sections 605. The cutting sections 605 are so-called perforations, and the medium S can be divided into a predetermined number of pieces at the perforations. The cutting sections 605 include a plurality of cutting sections 605 along the X-axis and a plurality of cutting sections 605 along the Y-axis. The smallest unit obtained by dividing the medium S at the cutting sections 605 has one processed section 601. Thus, the medium S can be divided and used according to, for example, a desired size and a desired number of processed sections 601.

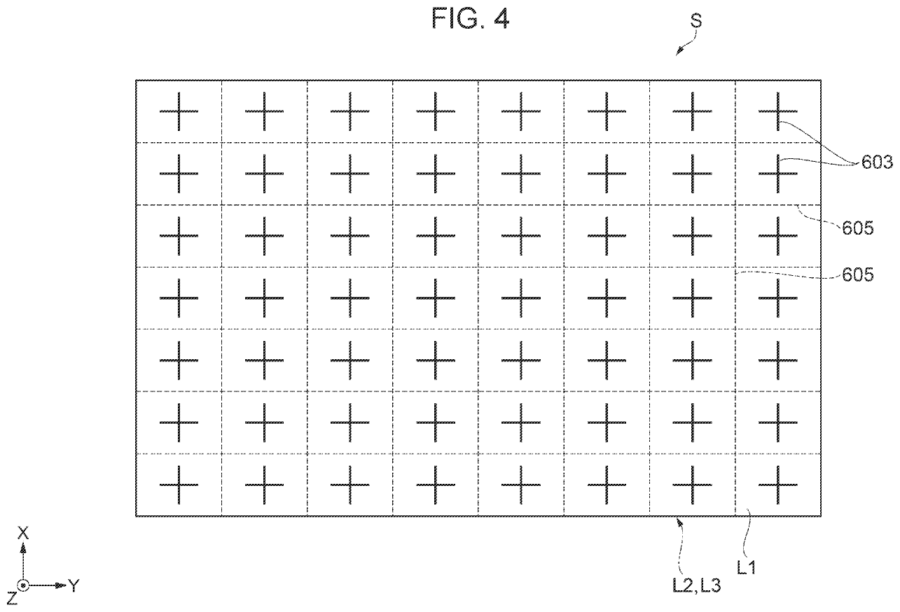

Referring to FIG. 4, the medium S may include a plurality of processed sections 603 instead of the processed sections 601 described above. The processed sections 603 are arrayed in a matrix along the X-axis and the Y-axis. If the first layer L1 is absent in the medium S, the second layer L2 has the processed sections 603.

The processed sections 603 each have a cross shape in plan view from above. Each processed section 603 is a partial cut formed in the first layer L1. The depth of the cut can be appropriately changed according to the type of mushroom to be cultivated. With the processed sections 603, mushroom mycelium is easily held in the cuts, and mushroom can grow in regions including the processed sections 603.

The form, number, and arrangement of the processed sections 601 and 603 and the cutting sections 605 described above are illustrative and not limited to those described above.

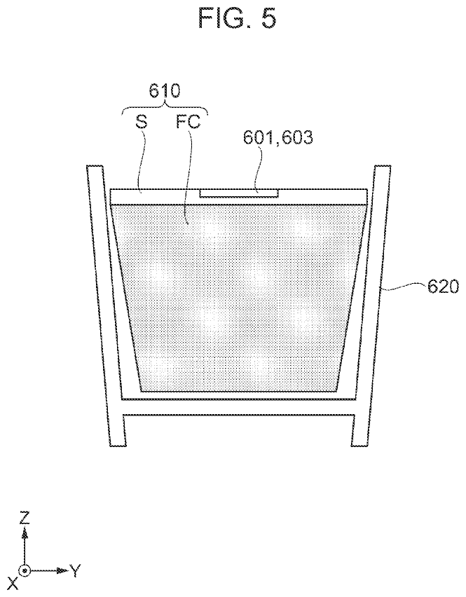

Referring to FIG. 5, the medium S may be used in a container 620, such as a pot. Specifically, a fiber processed product 610 including the medium S and a fiber aggregate FC under the medium S may be placed in the container 620. When the medium S is used in the container 620, the shape into which the medium S is divided at the cutting sections 605 described above conforms to the container 620.

The fiber aggregate FC is a cotton-like aggregate containing the cellulose fibers F. The fiber aggregate FC may contain additives, such as fertilizers. The fertilizers in the fiber aggregate FC may be the same as or different from the fertilizers in the medium S. The content of the fertilizers in the fiber aggregate FC may be higher than that in the second layer L2 of the medium S. The additives other than the fertilizers in the fiber aggregate FC may be the same as or different from those in the medium S.

The form of use of the medium S is not limited to that described above and, for example, the medium S may be used alone for cultivation.

### 2. Apparatus for Manufacturing Mushroom Cultivation Medium

In the formed-body manufacturing apparatus 500, a raw material of the cellulose fibers F is fibrillated into fibers by a dry process, and the fibers are then mixed with the wood chips C, the binder B, and other materials. The resulting mixture is pressed, heated, and cut to manufacture the medium S. In the following description, the cellulose fibers F are also referred to simply as fibers, and the raw material of the cellulose fibers F is also referred to simply as a raw material. The fiber aggregate FC described above may be manufactured in the formed-body manufacturing apparatus 500. The formed-body manufacturing apparatus 500 is illustrative and not limited to that described above.

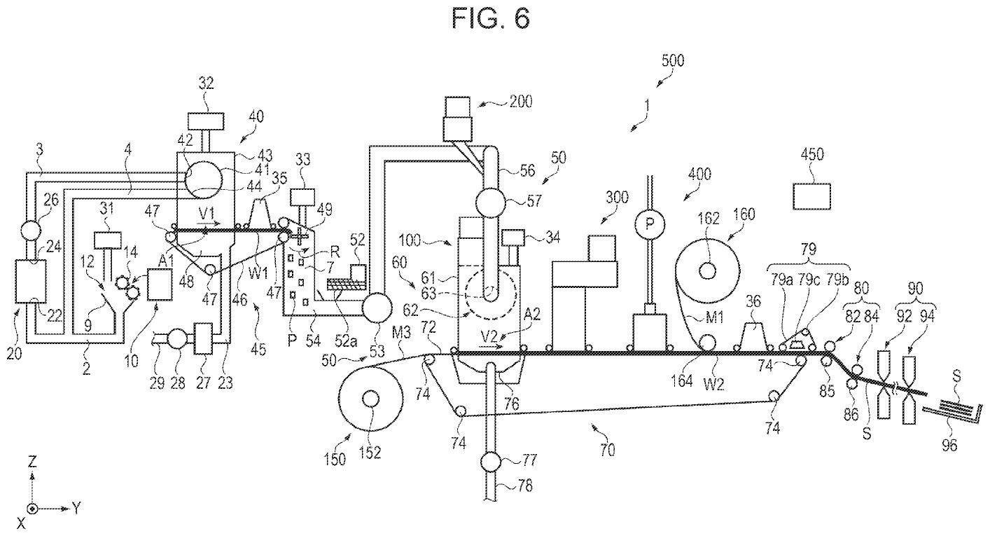

Referring to FIG. 6, the formed-body manufacturing apparatus 500 includes a web forming device 1, a transfer unit 79, a formed-body forming unit 80, a cutting unit 90, and a receiving unit 96. The web forming device 1 includes a raw material supply unit 10, a rough milling unit 12, a fibrillating unit 20, a sorting unit 40, a first web forming unit 45, a rotary body 49, a transport unit 50, a screen unit 60, a second web forming unit 70, a first supply unit 100, a second supply unit 200, a third supply unit 300, and a fourth supply unit 400.

The formed-body manufacturing apparatus 500 includes a humidifying mechanism for humidifying the raw material, a second web W2, and other materials. The humidifying mechanism includes a first humidifying unit 31, a second humidifying unit 32, a third humidifying unit 33, a fourth humidifying unit 34, a fifth humidifying unit 35, and a sixth humidifying unit 36. The humidifying mechanism adds moisture to suppress charging of the raw material, the second web W2, and other materials. This prevents or reduces attachment of the raw material and other materials to the inside of the formed-body manufacturing apparatus 500. The first humidifying unit 31, the second humidifying unit 32, the third humidifying unit 33, and the fourth humidifying unit 34 each include, for example, an evaporative or warm mist humidifier. The fifth humidifying unit 35 and the sixth humidifying unit 36 each include, for example, an ultrasonic humidifier.

The formed-body manufacturing apparatus 500 includes a controller 450. The controller 450 comprehensively controls the components of the web forming device 1 as well as the transfer unit 79, the formed-body forming unit 80, the cutting unit 90, the humidifying mechanism, and other members.

The raw material supply unit 10 supplies the raw material to the rough milling unit 12. The raw material supplied to the rough milling unit 12 is any raw material containing the cellulose fibers F. The raw material supply unit 10 has, for example, a stacker that stacks used paper or other paper, and an automatic feeding device that feeds paper into the rough milling unit 12 from the stacker.

The rough milling unit 12 has a pair of rough milling blades 14 and a rough milling blade drive unit (not shown). In the rough milling unit 12, the raw material supplied from the raw material supply unit 10 is cut into rough pieces with the pair of rough milling blades 14. The raw material is cut between the pair of rough milling blades 14 in a gas, such as atmosphere. The shape and size of the rough pieces are not limited as long as they are suitable for the fibrillating process in the fibrillating unit 20. In the rough milling unit 12, the raw material is cut into, for example, paper pieces with a size of one to several centimeters square, or smaller. The rough pieces obtained by cutting in the rough milling unit 12 pass through a first tube 2 via a chute 9 and are transported to the fibrillating unit 20.

The fibrillating unit 20 fibrillates the rough pieces obtained by cutting in the rough milling unit 12. In the fibrillating unit 20, the rough pieces are fibrillated to produce a fibrillated material. The fibrillation as used herein refers to the splitting of bonded fibers of the rough pieces into individual fibers. The fibrillating unit 20 also has a function of separating, from the fibers, the resin particles on the rough pieces and the resin particles, such as ink, toner, and a bleeding inhibitor.

The fibrillated material produced in the fibrillating unit 20 may contain, in addition to the split fibers, the resin particles separated from the fibers when the fibers are split into individual fibers. The split fibers have a string shape or a flat string shape. The fibrillated material may contain fiber groups of non-entangled fibers, that is, independent fibers, or may contain fiber groups of entangled fibers forming clumps of fibers, that is, fiber groups forming lumps of fibers.

In the fibrillating unit 20, fibrillating is performed by a dry process. The fibrillating unit 20 has, for example, an impeller mill. Although not shown, the impeller mill has a rotor that rotates at high speed, and a liner that surrounds the outer circumference of the rotor. The rough pieces obtained by cutting in the rough milling unit 12 are fibrillated between the rotor and the liner of the fibrillating unit 20.

In the fibrillating unit 20, the rotation of the rotor generates an airflow. In the fibrillating unit 20, the airflow causes the rough pieces to be suctioned from the first tube 2 through a rough piece inlet 22 and causes the fibrillated material to be discharged through a fibrillated material outlet 24. The fibrillated material is fed to a second tube 3 through the fibrillated material outlet 24 and transported to the sorting unit 40 through the second tube 3. The formed-body manufacturing apparatus 500 has a fibrillation blower 26, which is an airflow generator. The airflow generated by the fibrillation blower 26 accelerates the transport of the fibrillated material to the sorting unit 40.

The sorting unit 40 has a fibrillated material inlet 42. The fibrillated material flows into the sorting unit 40 from the second tube 3 through the fibrillated material inlet 42. The sorting unit 40 sorts the fibrillated material, which has flowed in through the fibrillated material inlet 42, according to the size of the fibrillated material.

Specifically, the sorting unit 40 sorts the fibrillated material into a first sorted material, which is a fibrillated material having a predetermined size or smaller, and a second sorted material, which is a fibrillated material larger than the first sorted material. The first sorted material contains fibers or particles shorter than a predetermined length and other materials. The second sorted material contains at least one selected from fibers longer than a predetermined length, non-fibrillated pieces, rough pieces that are not sufficiently fibrillated, reaggregates of fibrillated fibers, and lumps of entangled fibers.

The sorting unit 40 includes a first drum 41 and a first housing 43 containing the first drum 41. The first drum 41 is a cylindrical screen that has a mesh (not shown) and that is driven to rotate by a motor. In the first drum 41, the fibrillated material is sorted into a first sorted material smaller than the mesh size and a second sorted material larger than the mesh size.

The fibrillated material that has flowed in through the fibrillated material inlet 42 is fed into the first drum 41. The rotation of the first drum 41 causes the first sorted material to drop through the mesh openings of the first drum 41. The second sorted material that cannot pass through the mesh openings of the first drum 41 is guided to a sorted material outlet 44 by the airflow flowing into the first drum 41 through the fibrillated material inlet 42 and is fed to a third tube 4. The third tube 4 connects the inside of the first drum 41 to the first tube 2. The second sorted material that has been fed to the third tube 4 is returned to the fibrillating unit 20 and fibrillated again.

The first sorted material sorted in the first drum 41 is dispersed in air through the mesh openings of the first drum 41. The dispersed first sorted material falls down by gravity toward a first mesh belt 46 of the first web forming unit 45 located under the first drum 41.

The first web forming unit 45 has the first mesh belt 46, a plurality of belt transport rollers 47, and a first suction unit 48. The first mesh belt 46 is an endless belt. The first mesh belt 46 is stretched over three belt transport rollers 47. The rotation of the belt transport rollers 47 causes the first mesh belt 46 to rotate in a direction indicated by a first arrow Al.

The surface of the first mesh belt 46 is composed of a mesh with openings having a predetermined size. Among the particles of the first sorted material that drops from the sorting unit 40, the particles of the fibrillated material small enough to pass through the openings fall down below the first mesh belt 46. The particles of the fibrillated material too large to pass through the openings accumulate on the first mesh belt 46. This forms a first web W1 on the first mesh belt 46.

The first web W1 is transported in the direction indicated by the first arrow A1 with the rotation of the first mesh belt 46. Fine particles that drop from the first mesh belt 46 are, for example, particles smaller than a predetermined size contained in the fibrillated material. These particles are, for example, resin particles remaining between the fibers and are waste unnecessary for manufacture of the medium S.

The first mesh belt 46 rotates at a predetermined first velocity V1 during normal operation for manufacturing the medium S. The normal operation refers to the operation of the formed-body manufacturing apparatus 500 other than start control and stop control.

The first suction unit 48 suctions air from below the first mesh belt 46. The first suction unit 48 is connected to a dust collector 27 through a suction tube 23. The dust collector 27 is a filter or cyclone dust collecting unit. The dust collector 27 separates fine particles from the airflow and collects the fine particles. A collection blower 28 is disposed downstream of the dust collector 27. The collection blower 28 functions as a dust-collecting suction mechanism for suctioning air from the dust collector 27. The air discharged from the collection blower 28 is discharged to the outside of the formed-body manufacturing apparatus 500 through a discharge pipe 29.

Air containing water mist from the fifth humidifying unit 35 is supplied to the first web W1 on the first mesh belt 46. The mist generated by the fifth humidifying unit 35 falls down toward the first web W1 and adds moisture to the first web W1. Electrostatic attachment of fibers, fine particles, and other materials to the first mesh belt 46 is suppressed by the fifth humidifying unit 35 adjusting the water content of the first web W1.

The formed-body manufacturing apparatus 500 has the rotary body 49. The rotary body 49 divides the first web W1. The first web W1 is released from the first mesh belt 46 at a position at which the first mesh belt 46 is folded back by the belt transport roller 47. The released first web W1 is divided by the rotary body 49.

The rotary body 49 includes a rotary member having plate-shaped vanes. In the rotary member, the vanes are located in contact with the first web W1 released from the first mesh belt 46. The rotation of the rotary body 49 in the rotation direction R causes the vanes to collide with the first web W1 so as to divide the first web W1. The first web W1 is divided into small pieces P. The small pieces P are example fibers used as a main raw material of the second web W2 described below, that is, the second layer L2 of the medium S. The small pieces P are transported to the transport unit 50 by the airflow flowing inside a fourth tube 7.

The transport unit 50 has a binder supply unit 52, a first transport tube 54, and a mixing blower 53. The binder supply unit 52 supplies the binder B to the small pieces P. The first transport tube 54 communicates with the fourth tube 7. The airflow containing the small pieces P flows inside the first transport tube 54. The mixing blower 53 is disposed at the first transport tube 54.

The binder supply unit 52 is coupled to a cartridge (not shown) containing the binder B. The binder supply unit 52 supplies the binder B in the cartridge to the first transport tube 54. The binder supply unit 52 stores the binder B supplied from the cartridge. The binder supply unit 52 has a discharge unit 52a. The discharge unit 52a feeds the stored binder B to the first transport tube 54.

The mixing blower 53 has a rotary section (not shown), such as a vane. The mixing blower 53 generates airflow inside the fourth tube 7 and inside the transport unit 50. The mixing blower 53 mixes the small pieces P and the binder B with the rotation of the rotary section. The airflow generated by the mixing blower 53 causes the small pieces P and the binder B dropping inside the fourth tube 7 to be suctioned into the first transport tube 54.

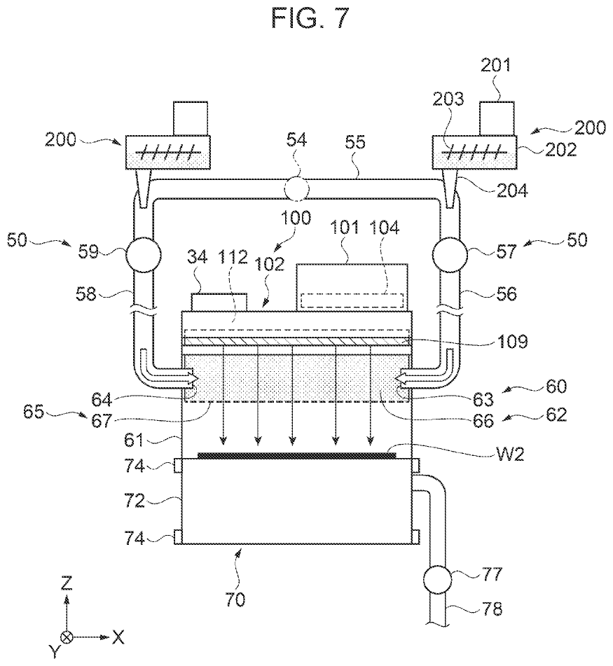

Referring to FIG. 6 and FIG. 7, the transport unit 50 includes a second transport tube 55, a third transport tube 56, two second supply units 200, a first blower 57, and a second blower 59. FIG. 7 illustrates the transport unit 50, the screen unit 60, the second web forming unit 70 as viewed in the negative Y-direction and illustrates the cross-sections of part of the third transport tube 56 and part of a fourth transport tube 58 and the inside of a second housing 61 of the screen unit 60.

The second transport tube 55 communicates with the first transport tube 54 and extends along the X-axis. The third transport tube 56 communicates with the second transport tube 55 in the positive X-direction and extends downward. One of the two second supply units 200 is disposed at the third transport tube 56. The first blower 57 is coupled to the third transport tube 56 under the one of the two second supply units 200.

The transport unit 50 has the fourth transport tube 58 and the second blower 59. The fourth transport tube 58 communicates with the second transport tube 55 in the negative X-direction and extends downward. The other of the two second supply units 200 is disposed at the fourth transport tube 58. The second blower 59 is coupled to the fourth transport tube 58 under the other second supply unit 200.

In the transport unit 50, the mixing blower 53 generates airflow inside the first transport tube 54. The transport unit 50 mixes the small pieces P and the supplied binder B by way of the generated airflow and transports the resulting mixture to the screen unit 60. The small pieces P and the binder B are transported to the screen unit 60 through the mixing blower 53 and the second transport tube 55.

The wood chips C are supplied from the two second supply units 200 to the mixture of the small pieces P and the binder B in the third transport tube 56 and in the fourth transport tube 58. Specifically, one of the second supply units 200 is coupled to the third transport tube 56 so as to communicate with the inside of the third transport tube 56. The other second supply unit 200 is coupled to the fourth transport tube 58 so as to communicate with the inside of the fourth transport tube 58. The two second supply units 200 each include a container 201, a storage chamber 202, and a connection conduit 204.

The container 201 is disposed above the storage chamber 202. The container 201 contains the wood chips C and supplies the wood chips C to the storage chamber 202. The storage chamber 202 stores the wood chips C supplied from the container 201. The storage chamber 202 has a feed mechanism 203.

The feed mechanism 203 stirs the wood chips C in the storage chamber 202 and transports the wood chips C to the connection conduit 204. One of the second supply units 200 supplies the wood chips C into the third transport tube 56 through the connection conduit 204. The other second supply unit 200 supplies the wood chips C into the fourth transport tube 58 through the connection conduit 204.

Although not shown, each container 201 may be replenished with the wood chips C after the wood chips C are prepared in a milling machine or other machines different from the formed-body manufacturing apparatus 500, or each container 201 may be directly replenished with the wood chips C prepared in a milling machine installed in each of the two second supply units 200. A mixture of the small pieces P, the binder B, and the wood chips C is transported toward a chamber 66 in the screen unit 60 through the third transport tube 56 and the fourth transport tube 58.

The third transport tube 56 and the fourth transport tube 58 extend downward toward the screen unit 60. The mixture supplied into the third transport tube 56 and the fourth transport tube 58 drops by gravity. The suction force of the first blower 57 and the second blower 59 may be smaller than the suction force of the mixing blower 53.

The screen unit 60 includes a second drum 62 and the second housing 61 containing the second drum 62. The second drum 62 includes the chamber 66 having a cylindrical shape. The chamber 66 has a first inlet 63 in communication with the third transport tube 56 and a second inlet 64 in communication with the fourth transport tube 58.

The chamber 66 contains the mixture of the small pieces P and the binder B introduced through the first inlet 63 and the second inlet 64, the wood chips C supplied from the second supply unit 200, and additives supplied from the first supply unit 100. The additives here refer to one or more powdery additives among the additives described above.

The second drum 62 is a cylindrical screen that is driven to rotate by a motor (not shown). The second drum 62 is rotatably held in the second housing 61 so as to rotate around the central axis of the screen. The central axis of the screen is a virtual axis along the X-axis. The second drum 62 may be rotatably held by the first inlet 63 and the second inlet 64 of the second housing 61.

The second drum 62 has a mesh 65. The mesh 65 functions as a screen. The mesh 65 is the circumferential surface that forms the chamber 66. In the second drum 62, fibers and particles smaller than the mesh size of mesh openings 67 of the mesh 65 pass through the mesh openings 67. The fibers and particles that have passed through the mesh openings 67 fall down from the second drum 62. The second drum 62 may have the same structure as the first drum 41. The mesh 65 of the second drum 62 is composed of, for example, a metal mesh, an expanded metal produced by stretching a metal plate with cuts, or a perforated metal produced by forming through-holes in a metal plate with a pressing machine.

The mixture of the small pieces P and the binder B that has passed through the transport unit 50 and the wood chips C supplied from the second supply units 200 are introduced into the chamber 66 through the first inlet 63 and the second inlet 64 along the trajectories indicated by the hollow arrows in FIG. 7.

The screen unit 60 loosens the entangled fibers and other materials and disperse them in air. The dispersed fibers and other materials drop toward a second mesh belt 72. In the screen unit 60, the additives supplied from the first supply unit 100 are introduced into the chamber 66 through the mesh openings 67 of the mesh 65. A mixture of the small pieces P, the binder B, the wood chips C, and the additives is screened by the screen unit 60 above the second mesh belt 72 of the second web forming unit 70.

The first supply unit 100 is configured to supply additives to the chamber 66 of the second drum 62. The additives supplied by the first supply unit 100 refer to one or more powdery additives among the additives described above.

The first supply unit 100 has a first container 101 and a supply mechanism 102. In the first supply unit 100, the first container 101 contains the additives supplied to the chamber 66 of the second drum 62. Although not shown, the bottom surface in a lower part of the first container 101 has an outlet through which the contained additives are discharged. The first container 101 includes a stirring mechanism 104 for stirring the contained additives.

The supply mechanism 102 stores the additives discharged through the outlet of the first container 101. The supply mechanism 102 includes a stirring mechanism 112 for stirring the additives. The supply mechanism 102 includes a supply roller 109 in a lower part. The supply roller 109 supplies the additives to the screen unit 60. The supply roller 109 is driven to rotate by a motor (not shown). The supply roller 109 rotates around the axis along the X-axis. The length of the supply roller 109 along the X-axis may be the same as or longer than the length of the second web W2 along the X-axis.

The second web forming unit 70 is disposed under the second drum 62. The second web forming unit 70 has a first substrate supply mechanism 150, the second mesh belt 72, a plurality of tension rollers 74, and a first suction mechanism 76.

The second web forming unit 70 accumulates a mixture of the small pieces P and the binder B that have passed through the screen unit 60, the wood chips C supplied from the second supply unit 200, and the additives supplied from the first supply unit 100. This forms a second web W2.

The first substrate supply mechanism 150 supplies a first substrate M3 onto the second mesh belt 72. The first substrate M3 serves as the third layer L3 described above in the medium S.

The first substrate supply mechanism 150 has a first support roller 152. The first support roller 152 supports a first substrate M3 having a roll shape. The first support roller 152 is driven to rotate by a drive mechanism (not shown) to supply the first substrate M3 onto the second mesh belt 72. When the medium S without the third layer L3 is manufactured, the supply of the first substrate M3 in the first substrate supply mechanism 150 is eliminated.

The second mesh belt 72 is an endless belt and stretched over the plurality of tension rollers 74. The rotation of the tension rollers 74 causes the second mesh belt 72 to run in a direction indicated by a second arrow A2 in FIG. 6.

The second mesh belt 72 is composed of, for example, a mesh with openings having a predetermined size. The second mesh belt 72 is made of, for example, metal, resin, cloth, or non-woven fabric. The mesh openings of the second mesh belt 72 have a size small enough to prevent the mixture dropping from the second drum 62 from passing through. The second mesh belt 72 moves at a second velocity V2 during normal operation for manufacturing the medium S. In the second web forming unit 70, the second web W2 is formed on the first substrate M3.

The first suction mechanism 76 is disposed under the second mesh belt 72. The first suction mechanism 76 includes a suction blower 77 at a suction channel 78. The first suction mechanism 76 generates downward airflow by way of the suction force of the suction blower 77. When the second web W2 is formed on the first substrate M3, the first suction mechanism 76 is not necessarily operated.

The second web W2 is an air-rich cotton-like body. The second mesh belt 72 transports the second web W2 together with the first substrate M3 toward the formed-body forming unit 80.

Referring to FIG. 6, the third supply unit 300 is disposed in the transport path of the second mesh belt 72 in the positive Y-direction from the screen unit 60. The third supply unit 300 supplies the additives onto the upper surface of the second web W2. The additives supplied by the third supply unit 300 refer to one or more powdery additives among the additives described above. The additives supplied by the first supply unit 100 may be the same as or different from the additives supplied by the third supply unit 300.

The fourth supply unit 400 is disposed in the transport path of the second mesh belt 72 in the positive Y-direction from the third supply unit 300. The fourth supply unit 400 supplies the additives onto the second web W2. The additives supplied by the fourth supply unit 400 refer to one or more liquid additives among the additives described above. The liquid additives as used herein include solutions or dispersions of the additives in water or other liquids.

The sixth humidifying unit 36 is disposed in the transport path of the second mesh belt 72 in the positive Y-direction from the fourth supply unit 400. The sixth humidifying unit 36 supplies mist-containing air to the second web W2. The water content of the second web W2 is adjusted by supplying mist to the second web W2.

A second substrate supply mechanism 160 is disposed in the transport path of the second mesh belt 72 between the fourth supply unit 400 and the sixth humidifying unit 36. The second substrate supply mechanism 160 supplies a second substrate M1 from above the second web W2 transported by the second mesh belt 72. The second substrate M1 serves as the first layer L1 described above in the medium S.

The second substrate supply mechanism 160 has a second support roller 162 and a substrate transport roller 164. The second support roller 162 supports the second substrate M1 having a roll shape. The second support roller 162 is driven to rotate by a drive mechanism (not shown). The second substrate M1 is thus supplied onto the second web W2.

The substrate transport roller 164 transports the second substrate M1 along the upper surface of the second web W2. When the medium S without the first layer L1 is manufactured, the supply of the second substrate M1 in the second substrate supply mechanism 160 is eliminated.

The second substrate supply mechanism 160 is not necessarily positioned between the fourth supply unit 400 and the sixth humidifying unit 36. The second substrate supply mechanism 160 may be positioned between the sixth humidifying unit 36 and the transfer unit 79.

The formed-body manufacturing apparatus 500 has the transfer unit 79. The transfer unit 79 transfers, to the formed-body forming unit 80, a multilayer body including the first substrate M3, the second web W2, and the second substrate M1 transported on the second mesh belt 72. The transfer unit 79 has a third mesh belt 79a, transfer rollers 79b, and a second suction mechanism 79c.

The second suction mechanism 79c includes a suction pump (not shown). The second suction mechanism 79c generates upward airflow at the third mesh belt 79a by way of the suction force of the suction pump. The second suction mechanism 79c accordingly suctions the multilayer body upward. The multilayer body is thus released from the second mesh belt 72 and suctioned against the third mesh belt 79a. The third mesh belt 79a is driven to rotate by the rotation of the transfer rollers 79b and transfers the multilayer body to the formed-body forming unit 80.

The formed-body forming unit 80 has a pressing member 82 and a heating member 84. The formed-body forming unit 80 presses and heats the multilayer body transferred by the transfer unit 79 to form the medium S. The formed-body forming unit 80 may form the fiber aggregate FC described above.

The pressing member 82 includes a pair of calendar rollers 85. The multilayer body is pressed between the pair of calendar rollers 85 at a predetermined nip pressure. When pressed, the multilayer body decreases in thickness. This increases the density of the second web W2. The multilayer body is transported to the heating member 84 from the pressing member 82 and exposed to heat.

One of the pair of calendar rollers 85 is a driving roller driven by a motor (not shown). The other of the pair of calendar rollers 85 is a driven roller. The calendar rollers 85 are rotated by driving the motor to transport the pressed multilayer body toward the heating member 84. When the fiber aggregate FC is formed, the pressing by the pressing member 82 may be eliminated.

The heating member 84 heats the multilayer body, so that the binder B in the second web W2 melts. The melted binder B is spread between the fibers in the second web W2. When the multilayer body decreases in temperature after passing through the heating member 84, the melted binder B solidifies, and the fibers are bound to each other with the binder B. The binder B may bind not only the fibers to each other, but also the fibers to the wood chips C, or the wood chips C to each other.

Examples of the heating member 84 include a heating roller, a hot press forming machine, a hot plate, a hot air blower, an infrared heater, and a flash fixer. The formed-body manufacturing apparatus 500 includes a pair of heating rollers 86 as the heating member 84.

One of the pair of heating rollers 86 is a driving roller driven by a motor (not shown). The other of the pair of heating rollers 86 is a driven roller. The pair of heating rollers 86 is heated to a predetermined set temperature by a heater placed inside or outside the rollers. The multilayer body pressed by the calendar rollers 85 is heated between the pair of heating rollers 86. The pair of heating rollers 86 is rotated by driving the motor and transports the multilayer body toward the cutting unit 90.

When the fiber aggregate FC is formed in the formed-body manufacturing apparatus 500, a hot air blower may be used as the heating member 84. The fiber aggregate FC including fibers bound to each other with a binding material is formed by heating the second web W2 with the hot air blower.

The multilayer body that has passed through the formed-body forming unit 80 has the same layer structure as the medium S. In other words, the multilayer body is the medium S prepared before being cut into substantially rectangular individual sheets.

The cutting unit 90 has a first cutting unit 92 and a second cutting unit 94. The cutting unit 90 cuts the medium S formed by the formed-body forming unit 80. The first cutting unit 92 cuts the medium S in a direction crossing the Y-axis. The second cutting unit 94 cuts, in the direction along the Y-axis, the medium S that has passed through the first cutting unit 92. The medium S is thus processed into individual sheets. The medium S is then discharged to the receiving unit 96. Although not shown, the receiving unit 96 has a tray or stacker that receives the medium S with a predetermined size.

The formed-body manufacturing apparatus 500 may have a processing unit (not shown). The processing unit forms the processed sections 601 and 603 and the cutting sections 605 described above in the medium S. The processed sections 601 and 603 are formed by using, for example, a pressing machine. The cutting sections 605 are formed by using, for example, a wheel cutter or a partial cutter. The processing unit may be disposed between the formed-body forming unit 80 and the cutting unit 90, or may be disposed between the cutting unit 90 and the receiving unit 96.

According to the embodiment, the following advantageous effects can be obtained. It is easy to maintain the shape of the medium S, and it is easy to handle the medium S. Specifically, the cellulose fibers F are easily entangled with the wood chips C, which enhances the bonding between the wood chips C. The cellulose fibers F are bound to each other with the binder B, which promotes the bonding between the wood chips C. This can provide the mushroom cultivation medium S that easily maintains its shape and that is easy to handle.

Since the medium S is formed through the pressing member 82, the voids in the second layer L2 become relatively small, and the growth of mushroom mycelium can be promoted. Since the medium S is manufactured by using the formed-body manufacturing apparatus 500, the type of wood chips C can be easily changed. It is thus easy to produce various types of media S.

What is claimed is:

1. A mushroom cultivation medium comprising:
cellulose fibers;
a binder binding the cellulose fibers to each other; and
wood chips mixed with the cellulose fibers.

2. The mushroom cultivation medium according to claim 1, wherein the wood chips include wood pieces from trees corresponding to a type of mushroom to be cultivated.

3. The mushroom cultivation medium according to claim 1, further comprising two surfaces facing each other, wherein
one of the two surfaces has a water-impermeable layer.

4. The mushroom cultivation medium according to claim 1, further comprising two surfaces facing each other, wherein
one of the two surfaces has a fiber sheet having a water-holding capacity.

5. The mushroom cultivation medium according to claim 1, wherein the cellulose fibers have an average fiber length of 0.5 mm or more and 2.0 mm or less.
